(19) United States
(12) Patent Application Publication
(10) Pub. No.: US 2014/0006163 A1
(43) Pub. Date: Jan. 2, 2014

(54) CONTEXT BASED MESSAGING SYSTEM

(71) Applicants: Uttam K. Sengupta, Portland, OR (US); Mark A. McCorkle, Oakland, CA (US); Conor P. Cahill, Waterford, VA (US); Kyle A. Short, Rancho Cordova, CA (US)

(72) Inventors: Uttam K. Sengupta, Portland, OR (US); Mark A. McCorkle, Oakland, CA (US); Conor P. Cahill, Waterford, VA (US); Kyle A. Short, Rancho Cordova, CA (US)

(21) Appl. No.: 13/976,058

(22) PCT Filed: Mar. 30, 2012
(86) PCT No.: PCT/US12/31331

§ 371 Date: Jun. 26, 2013

(51) Int. Cl. G06Q 30/02

(52) U.S. Cl. CPC G06Q 30/0261
USPC 705/14.58

(57) ABSTRACT

An embodiment of the invention provides context aware messaging. Such context aware messaging may include delivering communications (e.g., coupons, promotions) to mobile device users based on the device user's context (e.g., physical location, time of day and week, habits, tendencies, and the like). An embodiment includes sensing an environmental condition for a user; wirelessly communicating the sensed condition to a remotely located node; and receiving a context based communication in response to communicating the sensed condition to the remotely located node; wherein the context based communication corresponds to the sensed environmental condition. Other embodiments are described herein.

### BACKGROUND

Online messages, such as advertisements, promotions, coupons, and the like are sometimes delivered to users of mobile devices (e.g., Smartphones, tablets, mobile internet devices, cell phones, personal digital assistants) in a non-targeted, non-context aware fashion. For example, the messages may include coupons for physical stores located far from the mobile device user (thereby failing to appreciate the physical context of the user). As another example, the coupon may be delivered during a user's afternoon commute home even though the coupon is for a product that the user typically consumes in the morning (thereby failing to appreciate the temporal or emotional or habitual context of the user). Thus, many such non-context aware messages have poor success rates in terms of persuading the mobile device user to act on the message or conveying useful information to the user.

### BRIEF DESCRIPTION OF THE DRAWINGS

Features and advantages of embodiments of the present invention will become apparent from the appended claims, the following detailed description of one or more example embodiments, and the corresponding figures, in which:

FIG. 1 includes a schematic block diagram in an embodiment of the invention.

FIG. 2 includes a flow chart for a process in an embodiment of the invention.

FIG. 3 includes a graphical user interface (GUI) in an embodiment of the invention.

FIG. 4 includes a flow chart for a process in an embodiment of the invention.

FIG. 5 includes a system for use with various embodiments of the invention.

### DETAILED DESCRIPTION

In the following description, numerous specific details are set forth but embodiments of the invention may be practiced without these specific details. Well-known circuits, structures and techniques have not been shown in detail to avoid obscuring an understanding of this description. “An embodiment”, “various embodiments” and the like indicate embodiment(s) so described may include particular features, structures, or characteristics, but not every embodiment necessarily includes the particular features, structures, or characteristics. Some embodiments may have some, all, or none of the features described for other embodiments. “First”, “second”, “third” and the like describe a common object and indicate different instances of like objects are being referred to. Such adjectives do not imply objects so described must be in a given sequence, either temporally, spatially, in ranking, or in any other manner. “Connected” may indicate elements are in direct physical or electrical contact with each other and “coupled” may indicate elements co-operate or interact with each other, but they may or may not be in direct physical or electrical contact. Also, while similar or same numbers may be used to designate same or similar parts in different figures, doing so does not mean all figures including similar or same numbers constitute a single or same embodiment.

An embodiment of the invention provides context aware messaging. Such context aware messaging may include delivering communications (e.g., coupons, promotions) to mobile device users based on the device user's context (e.g., physical location, time of day and week, habits, tendencies, and the like). An embodiment includes sensing an environmental condition for a user; wirelessly communicating the sensed condition to a remotely located node; and receiving a context based communication in response to communicating the sensed condition to the remotely located node; wherein the context based communication corresponds to the sensed environmental condition. Thus, embodiments provide information that is more useful to the user because it accounts for the user's context.

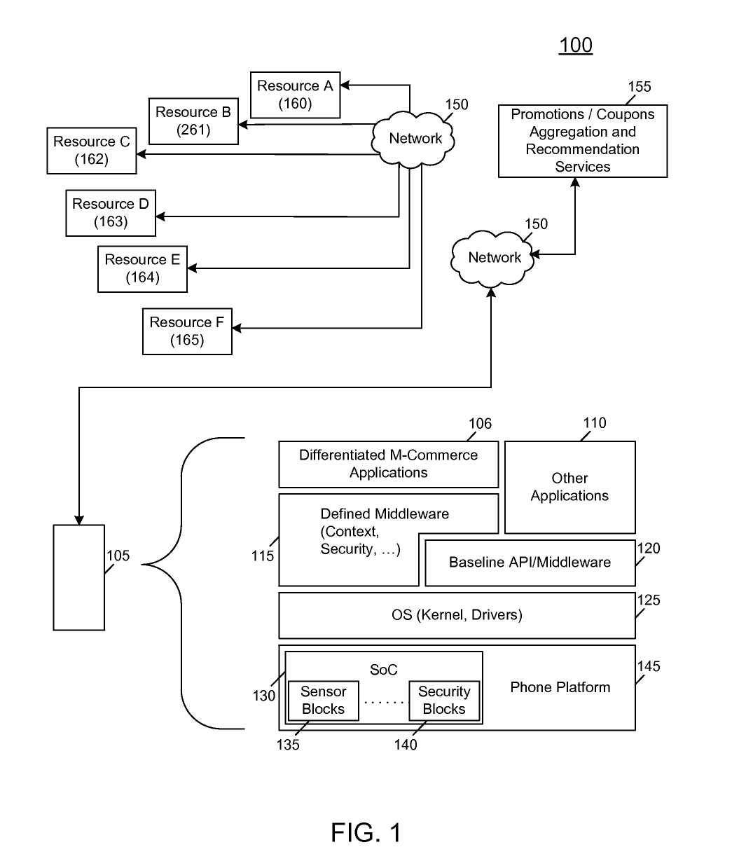

FIG. 1 includes system 100 based on a communications network 150, which includes the internet or any wired or wireless network. Network 150 couples mobile device 105 (e.g., Smartphone, personal digital assistant, tablet, notebook computer, radio, etc.) to a cloud based computing node 155 that, for example, generates and/or delivers promotions/coupons to users. Unit 155 may be included in a data center or hub including servers. Unit 155 couples, via network 150, to numerous resources A-F respectively numbered 160-165. The resources may include, for example, different vendors and social media outlets with which a user of device 105 interacts. For example, the resource may be as follows: 160 (grocery store), 161 (electronics vendor), 162 (clothing vendor), 163 (social media), 164 (internet browser having a browsing history), 165 (book and music vendor). Focusing on device 105, such a device may include a mobile commerce application 106, various other applications 110 (e.g., email, calendar, browser), middleware 115 that helps determine context for the user (e.g., physical location, speed, direction, time of day and week, heart rate) and/or manage device security, middleware 120 not specific to context based messaging, operation system 125, system-on-a-chip (SoC) 130 including sensor blocks (e.g., sensor to detect physical location, speed, direction, time of day and week, heart rate) 135, security blocks (Intel® Trusted Execution Technology hardware) 140, and general mobile device platform 145.

An embodiment uses system 100 to implement context aware messaging. For example, from a mobile device user's daily habits system 100 can determine travel routes (e.g., commute route) as well as key locations along those routes such as the user's home, office, gym, jogging path, grocery store, gas station, coffee shops, dry cleaner, and the like. System 100 is able to determine when the user will be on those routes based on, for example, entries in the user's calendar (e.g., an entry to work out at the gym) as well as gyroscope/accelerometer/global positioning system (GPS) metrics. For example, a user that repeatedly traces the same path between 7 and 8 a.m. during weekdays may be providing evidence of a commute path (which may be confirmed by querying the user as to whether a prospective route is indeed a commute path, whether a location that is starting point on most mornings and the ending point on most evenings is to be designated “home”, whether a location where most of one's time is spent during weekdays is to be designated “office”, and the like). This analysis is a form of data mining that, for example, mines data related to travel routes. Other opportunities for data mining exist. For example, from the user's online usage and shopping patterns system 100 may develop an understanding and comprehensive user profile based on the user's wish lists/shopping patterns (e.g., based on wish lists and reading lists created at on line vendors such as resources 161, 162, 165) and browsing habits (e.g., news and product reviews performed on resource 164).

Based on mined data, system 100 may determine a dynamic context for the user that likely changes throughout the day as the user moves about to different geographical locations, engages in different activities, and so on. Messaging that is appropriate for that context can then be sent to the user. For example, upon determining a user is on his daily commute to work and is near a coffee shop he has frequented in the past, system 100 may communicate a coupon to the user for discounted coffee (and, for example, possibly generate a coupon for discounted wine or groceries during the user's commute home in the evening) when the user is approaching the coffee shop. As the user increases his distance from the coffee shop the amount of discount may be increased in an effort to gain a coffee sale from a user that appears to be bypassing the coffee shop. Furthermore, determining a user is near the coffee shop but is there at a time when she or he typically does not frequent the shop (e.g., at 10:30 a.m. instead of 7:30 a.m. when the user typically visits the shop) system 100 may offer a more steeply discounted coupon to entice the user to consume coffee at a time that is not typical for the user to participate in such consumption. Also, the coupon may be for something other than what the user typically purchases at 7:30 a.m. For example, if a user typically buys a cup of coffee at 7:30 a.m., at 10:30 a.m. the coupon may be for a sandwich, a bag of unprocessed coffee beans, or a special mug to be used for future coffee purchases. Further, time limits may be placed on coupons. For prime time coupons (e.g., a Monday morning at 7:30 a.m. during the user's established commute) the coupon may be good for only 30 minutes but may be good all day long on non-primetime occasions (e.g., Sunday when the user typically does not frequent the coffee shop).

As another example, once system 100 determines a user is on his daily commute to work (e.g., based on determining the user is traveling along a route she or he historically takes at a particular time of day on a particular day of the week) system 100 can analyze local traffic conditions and offer alternative routes to work along with message that changes accordingly. For example, rather than send a coupon for the user's typical coffee shop, instead (or in addition to) offer a more steeply discounted coupon for a new coffee shop that is located near the proposed traffic-free/reduced traffic route. Also, when system 100 determines a user is located on a highway going 100 km/hour few coupons may be offered. However, when system 100 determines a user is traveling about 1 km/hour while located on a congested highway system 100 may offer coupons for on-line shopping such as a rain coat based on system 100 determining rain is forecast within the next 24 hours. Further still, when determining a user is possibly proceeding slowly through traffic, any time duration limit on a coupon may be extended to account for the delays a user may encounter while trying to get through traffic. In an embodiment, when proposing alternative travel routes to the user (e.g., to avoid traffic or simply to get from point A to point B for any reason) system 100 may propose a first route (which is the most direct route) and offer coupons for discounted flowers at 10% off However, system 100 may offer a second route (which is slightly more out of the way for the user) and offer a coupon for discounted flowers at 20% off to compensate the user for going out of his or her way (and still providing the further removed flower shop a sale it might have lost if not for the promotion). Also, in an embodiment when system 100 determines a user is jogging (e.g., based on rate of speed and rhythmic bouncing sensed by an accelerometer) system 100 may offer a coupon related to a sports drink.

As another example, system 100 may even add calendar entries to remind a user of various activities. For example, system 100 may mine data in the user's calendar and note an entry marked “anniversary” or “wedding anniversary”. System 100 may then offer the user an entry, placed one week before the “anniversary” entry, to “purchase anniversary gift” and/or offer a coupon for a jewelry store located near the user's daily commute. As another type of calendar entry, a calendar reminder may be for the expiration of a coupon that has already been presented to the user (e.g., via text, instant message, email, token, orally communicated, visually communicated via a GUI, and the like). For example, a coupon from a grocery store for 10% off bread may expire ten days after its issue. In such a case system 100 may present the user with a reminder on the tenth day on his or her way home from work.

In an embodiment a user may “opt into” data mining services that allow system 100 to mine data from device 105 as well cloud based activities for resources 160-165. For example, a user may allow data mining to occur based on some, all, or none of his or her GPS location, calendar entries (e.g., stored locally on device 105 or cloud-based calendars), and on-line cloud based shopping patterns (e.g., based on actual purchases or wish lists, stored in the cloud, corresponding to any of resources 160-165). Also, application 155 may be an avatar of sorts made to help the user. For example, the application may not necessarily be operated by an advertising organization and the like but instead may be a representative for the user to help the user better manage his or her day and his or her style of living. The data mined by the application may be shared with other parties, may be shared with severe to moderate restrictions, or may not be shared all according to the user's desire for privacy.

Sensors related to sensor blocks 135 are not restricted to sensors such as GPS devices, accelerometers, gyroscopes, and the like. Other sensors may, for example, cooperate with a vehicle fuel system (e.g., via a wireless communication protocol such as Bluetooth®) to indicate when a user's vehicle has a low amount of fuel. Such a sensed condition (which is deemed to be sensed by device 105 even though the actual sensor may be part of the vehicle system and not included in the chassis/body for device 105) may prompt a context based message concerning costs of fuel at the three most nearby fuel stations, as well as the locations for those devices, and/or whether those stations are on the same side of the road as the user and his vehicle (e.g., in North America a station located to the right of the user's direction of travel).

In an embodiment, activities for system 100 may be intermittent and context may be established at timed intervals (e.g., determine context every five minutes), based on sensed activity (e.g., based on whether an accelerometer coupled to system 105 notes movement of system 105), and the like.

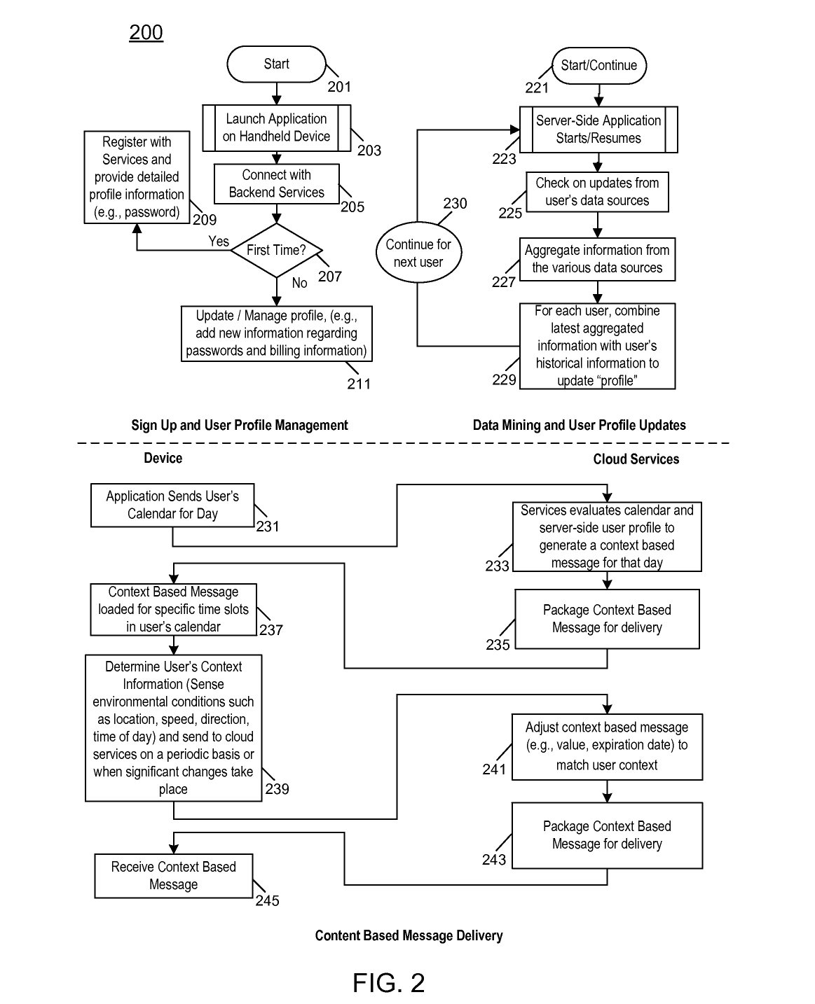

FIG. 2 includes various flow charts that may be used in cooperation with one another or independently of each other. Process 200 may begin at block 201 and in block 203 launch a context messaging application on a device such as device 105. In block 205 device 105 may wirelessly connect with backend services such as those services for any of resources 160-165. Using resource 160 as an example, block 207 determines if the application is connecting with resource 160 for the first time. If so, in block 209 the user may be prompted to register with resource 160 and provide profile information such as security passwords and credentials. Afterwards in block 211 such credentials are generally maintained (e.g., new or updated passwords and billing information are provided for resource 160). Thus, blocks 201-211 generally concern registering the application with various entities to manage a user's profile. This may be performed primarily on the device 105 platform.

In block 221 a data mining process begins. In block 223 a server or cloud based computing device and data mining application (e.g., block 155 of FIG. 1) operates. The mining application 155 may operate upon various events (e.g., a user of device 105 makes an on-line purchase or makes a calendar entry) and/or timer based conditions (e.g., once every ten minutes). In block 225 the server based application 155 may look for updates (e.g., calendar entries) for the registered user. In block 227 the data mining application 155 may aggregate information for the user from various resources, such as any of resources a 160-165. In block 229 the data mining application 155 combines the latest retrieved information with past information to create an updated user profile. The process may repeat for each user (block 230) that is registered with the cloud based data mining application 155.

In blocks 231 to 245 operations take place on multiple platforms, such as device 105 and cloud based application 155. In block 231 device 105 sends a user's calendar for the day to application 155. In block 233 application 155 evaluates the calendar against the user profile stored in the cloud by application 155. As described above, an entry for “anniversary” may spur a context based message (e.g., a coupon or promotion) for a jewelry purchase. In block 235 the message is packaged for delivery (e.g., according to a TCP/IP stack). In block 237 the message is loaded for a specific time slot in the user's device based calendar. For example, the jewelry based calendar entry described above may be placed one week before the calendar entry (and the same for subsequent years if the “anniversary” calendar entry repeats annually). In block 239 device 105 may dynamically determine the user's context (e.g., an updated GPS location, a rate of speed, a direction of travel) and send the updated context to application 155 on a periodic basis (e.g., every 15 minutes) or upon event changes (e.g., changing from traveling down a highway at 80 km/hour to sitting still at an office building). In block 241 application 155 adjusts its context based messaging. For example, coupons for a café in the bottom of the user's office building may be determined to be appropriate once device 105 understands the user's commute is complete. Then in blocks 243 and 245 the message is packaged and sent to the user device 105. An alert may be sent to the user as well.

In an embodiment, system 100 may aggregate coupons from, for example, the online environment and then selectively chose from the aggregated coupons and distribute those chosen coupons based on the user's context. This may lead to providing a user with a coupon that the user actually wants (finds useful) and that the user would otherwise not have.

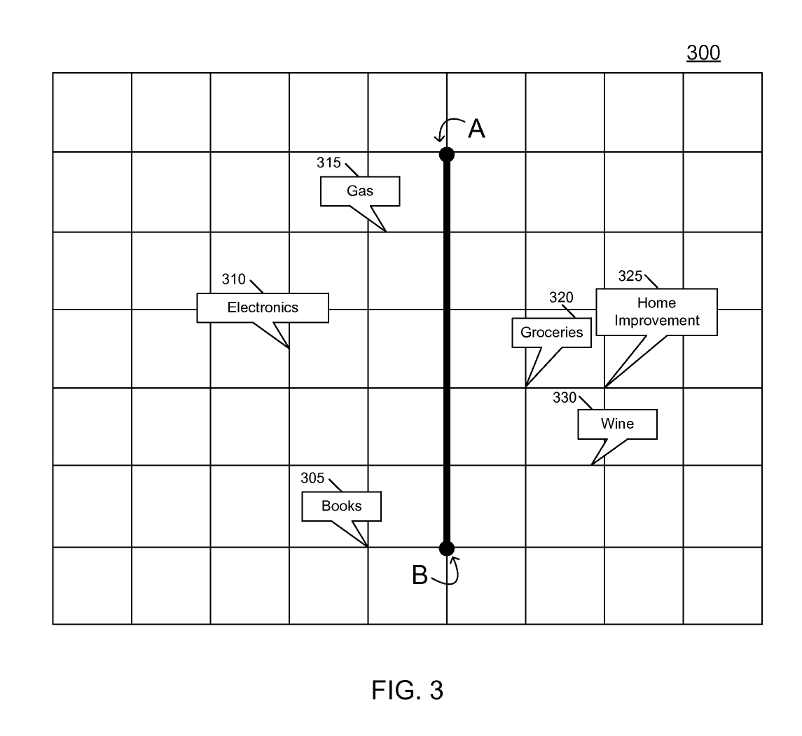

FIG. 3 includes an example of a GUI in an embodiment. The GUI illustrates how, based on a system (e.g., system 100) determining a user is commuting to or from work, different messages may be delivered to the user. For example, this GUI may be based on determining the user is commuting home on a Friday afternoon, and therefore suggests a deal on wine (block 330) as well as books to possibly read over the weekend (block 305). Other suggestions based on the late time of day and the coming weekend include discounted home improvement supplies (or even the mere existence of a home improvement store) (block 325). Other ideas may concern groceries with which to entertain weekend guests (block 320), electronics to televise an upcoming sporting event listed in the user's calendar (block 310). Gas may be advertised based on a gas level sensed in the user's car (block 315).

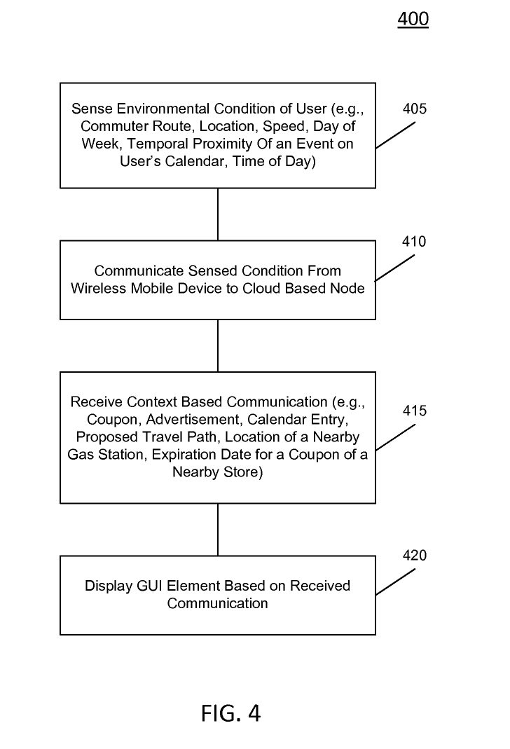

FIG. 4 includes a process in an embodiment of the invention. In block 405 a mobile computing node senses an environmental condition. Such a condition may include something related to the atmosphere (e.g., temperature, humidity, precipitation) but is not so limited and may pertain to the temporal (e.g., time of day, day of week, proximity to a calendar entry like a spouse's birthday), physical (e.g., location, speed of movement, direction of movement), and/or activity (e.g., running, walking, moving slowly in traffic) environment of the user. In block 410 the sensed condition is communicated to a cloud based node (e.g., server 155). In block 415 the user (e.g., via device 105) receives a context based communication based on the sensed condition. Such a communication may include an advertisement that is broadly interpreted herein, without limitation, to include at least a coupon, promotion (which can be a simple statement, message, and/or graphic regarding a vendor (e.g., location for the vendor), and the like. The communication may include a proposed travel path (e.g., jogging path, commute route to avoid traffic), and the like. In block 420 a GUI (e.g., see FIG. 3) may include an element based on the communication (e.g., block 330 of FIG. 3).

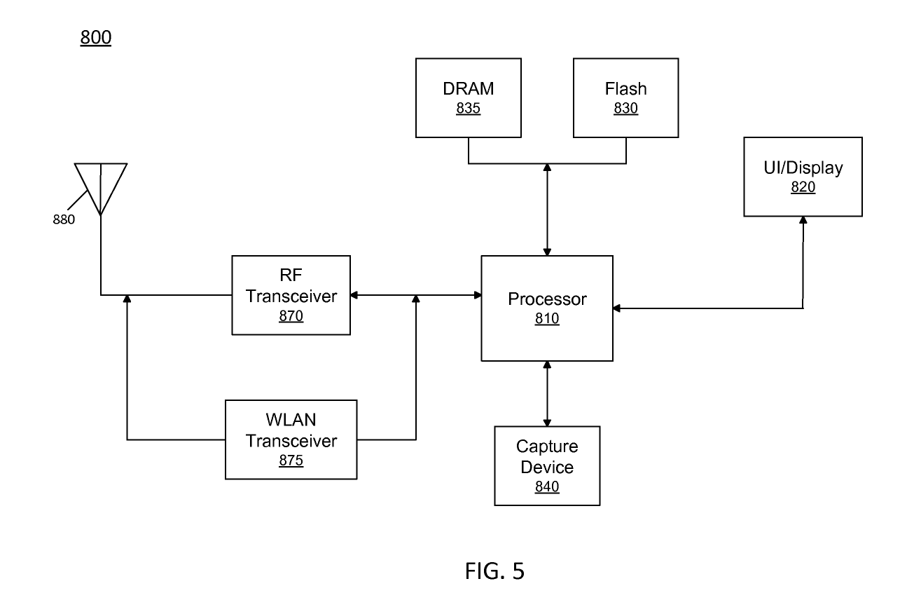

Embodiments can be used in many different environments. FIG. 5 includes a block diagram of an example system 800 with which embodiments can be used. System 800 may be a Smartphone, cell phone, mobile internet device, tablet, or other wireless communicator or computer node. System 800 may include at least one processor 810 (e.g., baseband processor, microprocessor, application processor, and the like). Processor 810 can perform various signal processing with regard to communications, as well as perform computing operations for the device. In turn, processor 810 can couple to a user interface/display 820 which can be realized in some embodiments by a touch screen display. In addition, processor 810 may couple to a memory system including non-volatile memory, such as flash memory 830 and/or a system memory such as dynamic random access memory (DRAM) 835. As further seen, processor 810 can further couple to a capture device 840 such as an image capture device that can record video and/or still images. To enable communications to be transmitted and received circuitry may be coupled between processor 810 and antenna 880. Specifically, radio frequency (RF) transceiver 870 and wireless local area network (WLAN) transceiver 875 may be present. In general, RF transceiver 870 may be used to receive and transmit wireless data and calls according to a given wireless communication protocol such as 3G or 4G wireless communication protocol such as in accordance with a code division multiple access (CDMA) global system for mobile communication (GSM), long term evolution (LTE) or other protocol. Other wireless communications such as receipt or transmission of radio signals (e.g., AM/FM), or global positioning satellite (GPS) signals may also be provided. In addition, via WLAN transceiver 875, local wireless signals, such as according to a Bluetooth® standard or an IEEE 802.11 standard such as IEEE 802.11a/b/g/n can also be realized. Although shown at this high level system depiction, understand the scope of the present invention is not limited in this regard.

An embodiment includes sensing an environmental condition for a user; wirelessly communicating the sensed condition to a remotely located computing node; and receiving a context based communication in response to communicating the sensed condition to the remotely located computer node; wherein the context based communication corresponds to the sensed environmental condition. An embodiment comprises annotating a calendar based on the context based communication. An embodiment comprises the context based communication including an advertisement. In an embodiment the sensed environmental condition is based on a geographic location for the user at the time of sensing the environmental condition. An embodiment includes sensing an additional environmental condition for the user non-simultaneously with sensing the environmental condition for the user; wirelessly communicating the additional sensed condition to the remotely located computer node; and receiving an additional context based communication in response to communicating the additional sensed condition to the remotely located computer node; wherein (a) the additional context based communication corresponds to the additional sensed environmental condition, (b) the context based communication includes an advertisement for a product and the additional context based communication includes an additional advertisement for the product, and (c) the advertisement and the additional advertisement include different promotions for the product. An embodiment includes sensing an additional environmental condition for the user non-simultaneously with sensing the environmental condition for the user; wirelessly communicating the additional sensed condition to the remotely located computer node; wherein the context based communication corresponds to the sensed environmental condition and the sensed additional environmental condition. In an embodiment the advertisement includes one of a promotion, a coupon, and a price for a product. An embodiment includes sensing an additional environmental condition for the user within five minutes of sensing the environmental condition for the user; and wirelessly communicating the additional sensed condition to the remotely located computer node; wherein the context based communication corresponds to the sensed environmental condition and the sensed additional environmental condition. In an embodiment the sensed environmental condition is based on a direction of travel for the user at the time of sensing the environmental condition for the user. In an embodiment the sensed environmental condition is based on a speed and a direction of travel for the user at the time of sensing the environmental condition for the user. In an embodiment the sensed environmental condition includes a time of day for the user at the time of sensing the environmental condition for the user. In an embodiment the advertisement is based on one of a calendar entry for the user, a record for an item the user previously purchased on-line, and a fuel level for a vehicle. An embodiment includes sensing multiple additional instances of the environmental condition for the user over a multi-day time period; and wirelessly communicating the multiple instances to the remotely located computer node; wherein the context based communication corresponds to the multiple instances of the sensed environmental condition. In an embodiment (a) the sensed environmental condition is based on a geographic location for the user at the time of sensing the environmental condition for the user; (b) the context based communication includes a coupon having a discount value, and (c) the size of the discount value is based on the geographic location for the user and a geographic location of a vendor that corresponds to the coupon. An embodiment includes determining a travel route for the user based on the sensed environmental condition; wherein the context based communication corresponds to the travel route. An embodiment may include at least one memory and at least one processor, coupled to the at least one memory, to perform operations comprising: sensing an environmental condition for a user; wirelessly communicating the sensed condition to a remotely located computing computer node; and receiving a context based communication in response to communicating the sensed condition to the remotely located computer node; wherein the context based communication corresponds to the sensed environmental condition. In an embodiment the context based communication includes an advertisement. In an embodiment (a) the sensed environmental condition is based on a geographic location for the user at the time of sensing the environmental condition for the user; (b) the context based communication includes a coupon having a discount value, and (c) the size of the discount value is based on the geographic location for the user and a geographic location of a vendor that corresponds to the coupon.

Embodiments may be implemented in code and may be stored on at least one storage medium having stored thereon instructions which can be used to program a system to perform the instructions. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

Embodiments of the invention may be described herein with reference to data such as instructions, functions, procedures, data structures, application programs, configuration settings, code, and the like. When the data is accessed by a machine, the machine may respond by performing tasks, defining abstract data types, establishing low-level hardware contexts, and/or performing other operations, as described in greater detail herein. The data may be stored in volatile and/or non-volatile data storage. The terms “code” or “program” cover a broad range of components and constructs, including applications, drivers, processes, routines, methods, modules, and subprograms and may refer to any collection of instructions which, when executed by a processing system, performs a desired operation or operations. In addition, alternative embodiments may include processes that use fewer than all of the disclosed operations, processes that use additional operations, processes that use the same operations in a different sequence, and processes in which the individual operations disclosed herein are combined, subdivided, or otherwise altered.

In one embodiment, use of the term control logic includes hardware, such as transistors, registers, or other hardware, such as programmable logic devices. However, in another embodiment, logic also includes software or code. Such logic may be integrated with hardware, such as firmware or micro-code. A processor or controller may include control logic intended to represent any of a wide variety of control logic known in the art and, as such, may well be implemented as a microprocessor, a micro-controller, a field-programmable gate array (FPGA), application specific integrated circuit (ASIC), programmable logic device (PLD) and the like.

All optional features of apparatus(s) described above may also be implemented with respect to method(s) or process(es) described herein. While the present invention has been described with respect to a limited number of embodiments, those skilled in the art will appreciate numerous modifications and variations therefrom. It is intended that the appended claims cover all such modifications and variations as fall within the true spirit and scope of this present invention.

1. At least one machine readable medium comprising instructions that when executed on a computing device cause the computing device to perform a method comprising:
sensing an environmental condition for a user;
wirelessly communicating the sensed condition to a remotely located computing node; and
receiving a context based communication in response to communicating the sensed condition to the remotely located computer node;
wherein the context based communication corresponds to the sensed environmental condition.

2. The at least one medium of claim 1, the method comprising annotating a calendar based on the context based communication.

3. The at least one medium of claim 1, wherein the context based communication includes an advertisement.

4. The of claim 3, wherein the sensed environmental condition is based on a geographic location for the user at the time of sensing the environmental condition.

5. The at least one medium of claim 3, the method comprising:
sensing an additional environmental condition for the user non-simultaneously with sensing the environmental condition for the user;
wirelessly communicating the additional sensed condition to the remotely located computer node; and
receiving an additional context based communication in response to communicating the additional sensed condition to the remotely located computer node;
wherein (a) the additional context based communication corresponds to the additional sensed environmental condition, (b) the context based communication includes an advertisement for a product and the additional context based communication includes an additional advertisement for the product, and (c) the advertisement and the additional advertisement include different promotions for the product.

6. The at least one medium of claim 3, the method comprising:
sensing an additional environmental condition for the user non-simultaneously with sensing the environmental condition for the user; and
wirelessly communicating the additional sensed condition to the remotely located computer node;
wherein the context based communication corresponds to the sensed environmental condition and the sensed additional environmental condition.

7. The at least one medium of claim 3, wherein the advertisement includes one of a promotion, a coupon, and a price for a product.

8. The at least one medium of claim 3, the method comprising:
sensing an additional environmental condition for the user within five minutes of sensing the environmental condition for the user; and
wirelessly communicating the additional sensed condition to the remotely located computer node;
wherein the context based communication corresponds to the sensed environmental condition and the sensed additional environmental condition.

9. The at least one medium of claim 3, wherein the sensed environmental condition is based on a direction of travel for the user at the time of sensing the environmental condition for the user.

10. The at least one medium of claim 3, wherein the sensed environmental condition is based on a speed and a direction of travel for the user at the time of sensing the environmental condition for the user.

11. The at least one medium of claim 3, wherein the sensed environmental condition includes a time of day for the user at the time of sensing the environmental condition for the user.

12. The at least one medium or claim 3, wherein the advertisement is based on one of a calendar entry for the user, a record for an item the user previously purchased on-line, and a fuel level for a vehicle.

13. The at least one medium of claim 1, the method comprising:
sensing multiple additional instances of the environmental condition for the user over a multi-day time period; and
wirelessly communicating the multiple instances to the remotely located computer node;
wherein the context based communication corresponds to the multiple instances of the sensed environmental condition.

14. The at least one medium of claim 1, wherein (a) the sensed environmental condition is based on a geographic location for the user at the time of sensing the environmental condition for the user; (b) the context based communication includes a coupon having a discount value, and (c) the size of the discount value is based on the geographic location for the user and a geographic location of a vendor that corresponds to the coupon.

15. The at least one medium of claim 1, the method comprising:
determining a travel route for the user based on the sensed environmental condition;
wherein the context based communication corresponds to the travel route.

16. (canceled)

17. (canceled)

18. (canceled)

19. An apparatus comprising:
at least one memory and at least one processor, coupled to the at least one memory, to perform operations comprising:
sensing an environmental condition for a user;
wirelessly communicating the sensed condition to a remotely located computing computer node; and
receiving a context based communication in response to communicating the sensed condition to the remotely located computer node;
wherein the context based communication corresponds to the sensed environmental condition.

20. The apparatus of claim 19, wherein the context based communication includes an advertisement.

21. The apparatus of claim 19, wherein (a) the sensed environmental condition is based on a geographic location for the user at the time of sensing the environmental condition for the user; (b) the context based communication includes a coupon having a discount value, and (c) the size of the discount value is based on the geographic location for the user and a geographic location of a vendor that corresponds to the coupon.

22. A method executed by at least one processor comprising:
sensing an environmental condition for a user;
wirelessly communicating the sensed condition to a remotely located computing node; and
receiving a context based communication in response to communicating the sensed condition to the remotely located computer node;
wherein the context based communication corresponds to the sensed environmental condition.

23. The method of claim 22, wherein the context based communication includes an advertisement.

24. The method of claim 22, wherein (a) the sensed environmental condition is based on a geographic location for the user at the time of sensing the environmental condition for the user; (b) the context based communication includes a coupon having a discount value, and (c) the size of the discount value is based on the geographic location for the user and a geographic location of a vendor that corresponds to the coupon.
